(19) United States
(12) Patent Application Publication
(10) Pub. No.: US 2003/0222101 A1
(43) Pub. Date: Dec. 4, 2003

(54) Adapter for a suction device

(76) Inventor: Ti-Li Chang, Hsien (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/157,342

(22) Filed: May 29, 2002

(51) Int. Cl. B67D 1/16

(52) U.S. Cl. 222/108

(57) ABSTRACT

An adapter for a suction device consists of a container (10), an anti-leak base (20) mounted on the container (10), a liquid level controller (30) attached to the anti-leak base (20) and inserted into the container (10) and a cap (40) to hold the anti-leak base (20) inside and detachably attach to the container (10). A liquid nipple and an air nipple are formed on the cap (40), and a knob (70) is rotatably mounted on the cap (40). The anti-leak base (20) has a division wall (23) with an outer periphery extending up from part of the edge and a liquid guide trench (24) in the outer periphery to operationally align with the liquid nipple (41). By turning the knob (70), the division wall (23) is aligned to block the liquid nipple (41) tightly to provide an excellent seal.

### BACKGROUND OF THE INVENTION

1. Field of the Invention

The present invention relates to an adapter for a suction device, and more particularly to an adapter used with a hand held portable suction device that does not leak when being used.

2. Description of Related Art

A suction device provides quick and effective pharyngeal and tracheal suction during multiple types of emergencies. With reference to FIGS. 6 and 7, a conventional suction device is a light portable suction device that can be operated with one hand and allows the other hand to be free for other important duties. The conventional suction device comprises an adapter (80) and a vacuum gun (90).

The adapter (80) consists of a container (81) and a cap (82) mounted on the container (81). The container (81) is essentially a jar with an opening (not numbered) at the top and has an external thread (not numbered) formed around the opening. The cap (82) is an elongated cap with an internal thread (not numbered) corresponding to the thread on the container (81) to attach the cap (82) to the container (81). A liquid inlet nipple (83) and an air outlet nipple (84) are formed on the cap (82) to communicate with a liquid extraction tube (91) and the vacuum gun (90), respectively. Two check valves (85) are secured at junctions between the nipples (83, 84) and the cap (82) to prevent liquid from flowing back into the liquid extraction tube (91) or into the air outlet nipple (84). An air chamber (86) is formed inside the cap (82) around the check valve (85) attached to the air outlet nipple (84). A nipple (861) is formed on the bottom of the air chamber (86) and projects downward into the container (81). An extension tube (87) is attached to the nipple (861) and has a first and second end (not numbered). The first end is connected to the nipple (861) on the air chamber (86), and a float check valve (88) is connected to the second end. The float check valve (88) is essentially a hollow tube with a narrow connector (881) that is pressed into the second end of the extension tube (87). Additionally, a liquid check valve (89) is mounted inside the float check valve (88).

To operate the suction device, the liquid extraction tube (91) is inserted into patient's trachea, throat or other place fluid or phlegm needs to be removed. Then, the vacuum gun (90) is triggered to remove air from the container (81) to provide the necessary force to draw fluid out of the patient's body. The fluid flows into the container (81) via the liquid extraction tube (91) and the liquid inlet nipple (83). When the fluid level in the container (80) increases to a sufficient level to reach the liquid check valve (89), the liquid check valve (89) is raised by the liquid and blocks the channel of the narrow connector (881) to automatically stop the suction operation.

However, the conventional suction device has the following drawback. When the suction device is not standing upright and the vacuum gun (90) is operated intentionally or inadvertently, fluid in the container flows into the air chamber (86) and possibly to the vacuum gun (90) to cause contamination of the air chamber (86) and damage to the vacuum gun (90). Therefore, the adapter (80) does not provide an effective liquid seal.

The present invention has arisen to mitigate and/or obviate the disadvantage of the conventional adapter for a suction device.

### SUMMARY OF THE INVENTION

The main objective of the invention is to provide an adapter for a suction device, which has an excellent liquid seal.

Other advantages and novel features of the invention will become more apparent from the following detailed description when taken in conjunction with the accompanying drawings.

### BRIEF DESCRIPTION OF THE DRAWINGS

FIG. 1 is a perspective view of an adapter for a suction device in accordance with the present invention;

FIG. 2 is an exploded perspective view of the adapter for a suction device in FIG. 1;

FIG. 3 is a cross-sectional side plan view of the adapter along line 3-3 in FIG. 1, wherein the adapter is mounted on a vacuum gun;

FIG. 4 is a cross-sectional top plan view of the adapter along line 4-4 in FIG. 3;

FIG. 5 is an operational cross-sectional top plan of the adapter in FIG. 4;

FIG. 6 is a side plan view of a conventional adapter for a suction device in accordance with the prior art; and

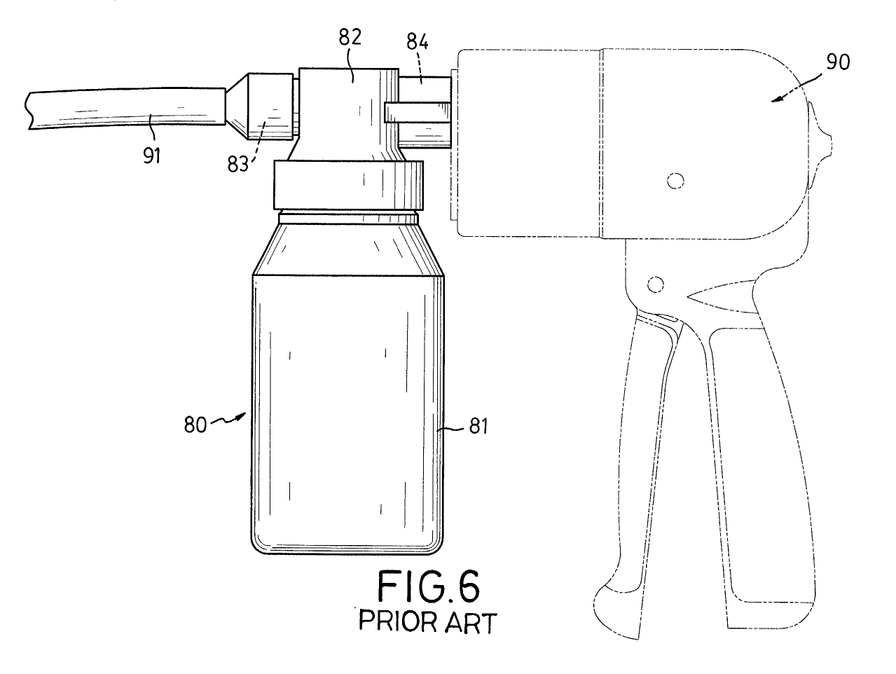

FIG. 7 is cross-sectional side plan view of the conventional adapter in FIG. 6.

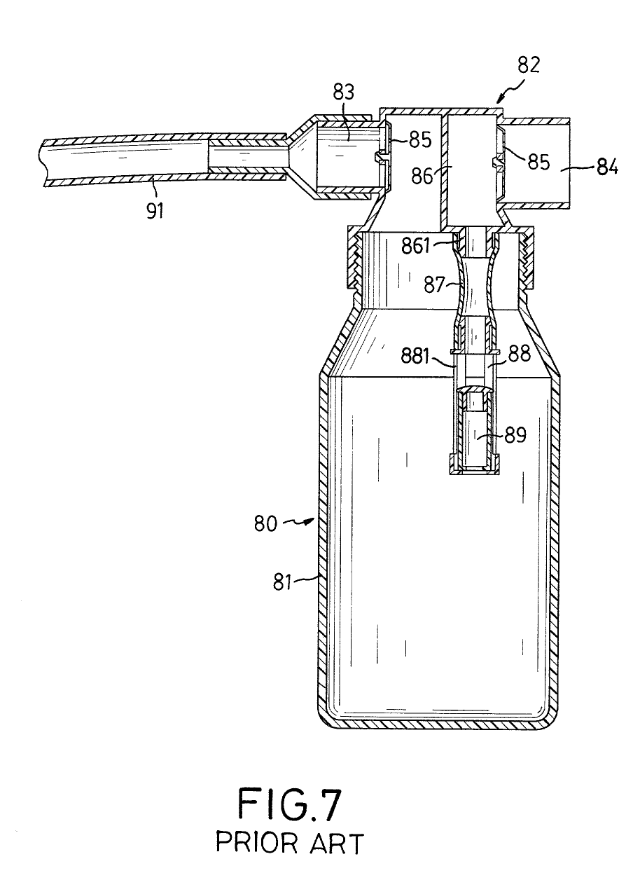

### DETAILED DESCRIPTION OF THE PREFERRED EMBODIMENT

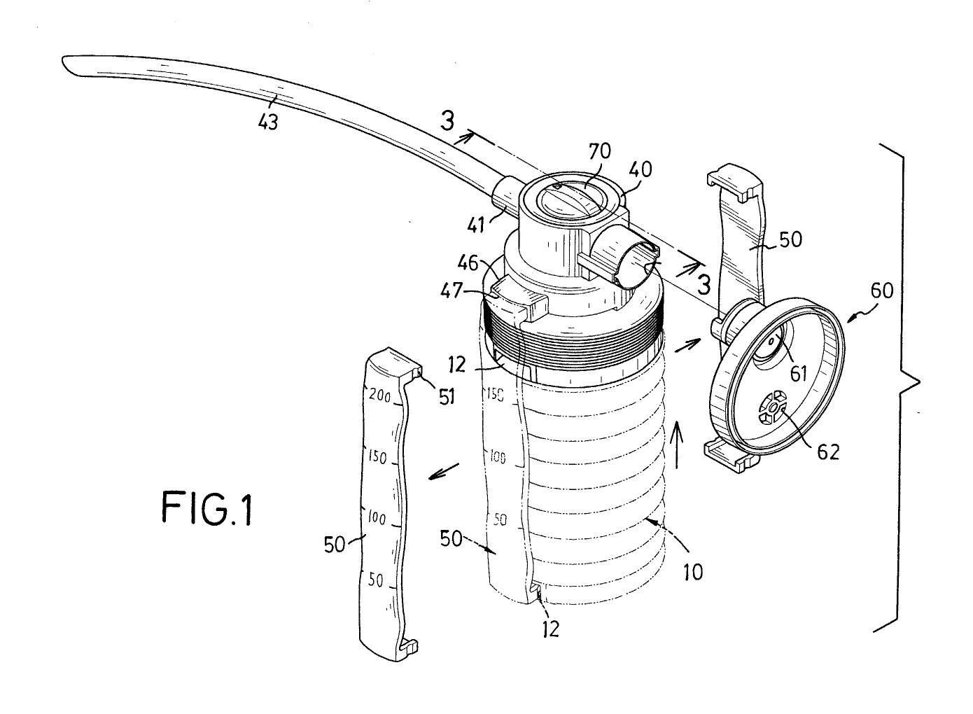

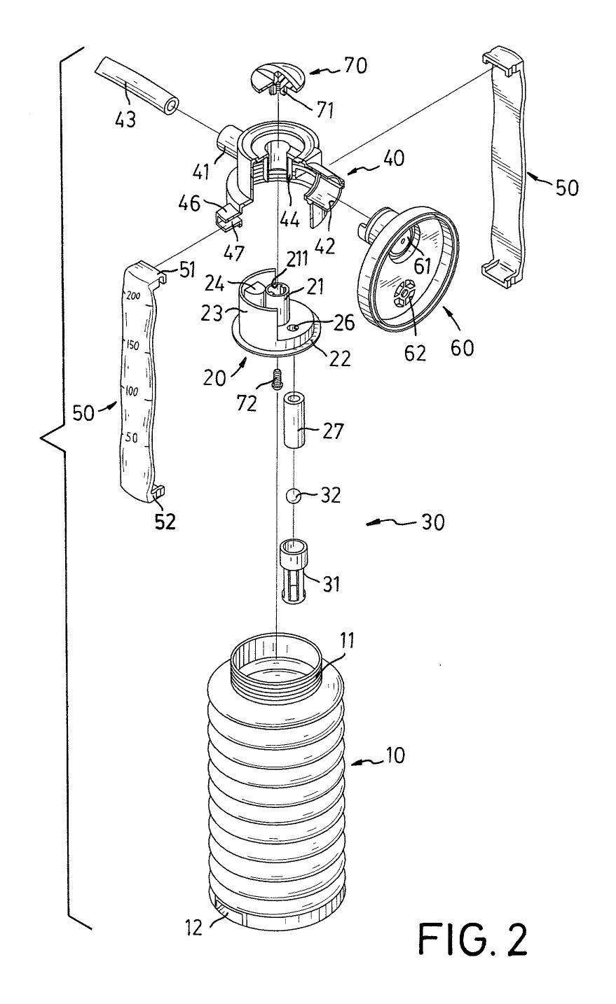

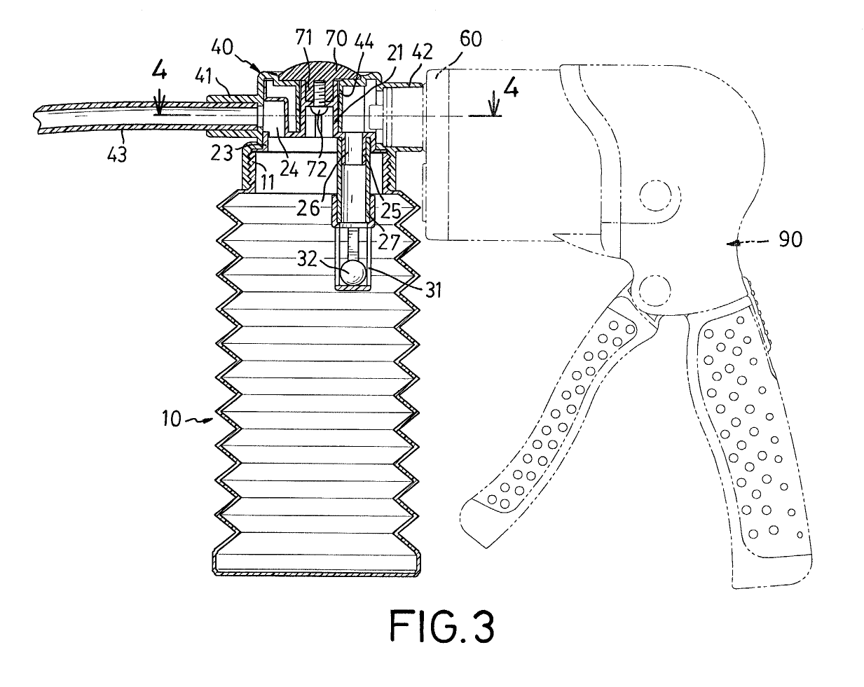

With reference to FIGS. 1 to 3, an adapter for a suction device in accordance with the present invention comprises a container (10), a anti-leak base (20), a liquid level controller (30) and a cap (40).

The container (10) has a top and a bottom with an opening (not numbered) at the top and an external thread (11) formed around the opening. Below the thread (11) around the opening, the container (10) is foldable, and at least one mounting hole (12) is defined near the bottom of the container (10).

The anti-leak base (20) is mounted on the opening in the container (10). The anti-leak base (20) is a round plate with a top surface and a bottom surface and has a first cylindrical protrusion (21), a rim (22), a division wall (23) with a liquid guide (24), a nipple (25) with a through hole (26) and an extension tube (27). The first cylindrical protrusion (21) is formed at the center on the top surface of the round plate, and a longitudinal hole (211) is defined in the first cylindrical protrusion (21). The rim (22) is formed around an outer periphery of the round plate (20), and the nipple (25) with the through hole (26) is formed downward from the bottom surface of the round plate (20). The extension tube (27) has a first end (not numbered) and a second end (not numbered) and communicates between the nipple (25) and the floating liquid level controller (30). The division wall (23) with an outer periphery extends upward from part of the rim (22) of the round plate. The liquid guide (24) is defined inside the outer periphery of the division wall (23).

The liquid level controller (30) consists of a check valve (31) connected to the second end of the extension tube (27) and a floating ball (32) movably mounted inside the check valve (31). Multiple longitudinal holes (not numbered) are defined in the check valve (31) to allow the liquid inside the container (10) to flow into the check valve (31).

The cap (40) mounted on the container (10) is a hollow round housing having a top face (not numbered) and is divided into an upper portion (not numbered) and a lower portion (not numbered). The lower portion has a larger diameter than the upper portion. A liquid nipple (41) and an air nipple (42) are formed on the upper portion of the cap (40), and each has a free end extend outward from the cap (40). A liquid extraction tube (43) is connected the free end of the liquid nipple (41). A hole (not numbered) is defined in the top face of the cap (40), and a positioning lining (44) is formed around the inside of the hole. A knob (70) is rotatably secured on the top face of the cap (40), and a shaft (71) with a coaxial threaded hole (not numbered) is formed on a bottom face of the knob (70). The shaft (71) penetrates the hole and is securely attached to the first cylindrical protrusion (21) by a screw (72). Thus, the knob (70) can be used to rotate the anti-leak base (20) mounted inside the upper portion of the cap (40). At least one bracket (46) is formed on an outer periphery of the lower portion of the cap (40) at position corresponding to the at least one of the mounting holes (12) in the container (10).

Additionally, at least one scale (50) is longitudinally mounted on the container (10) in the bracket (46) and the corresponding mounting hole (12). Each scale (50) has a hook (51) firmly held in a recess (47) in the bracket (46) and a wedge block (52) firmly secured inside the mounting hole (12) in the container (12). The scale (50) is used to measure the level of the liquid in the container (10).

A suction cap (60) is detachably adapted to connect between the connecting cap (40) and a vacuum gun (90). The suction cap (60) comprises an air tube (not numbered), a check valve (61) and multiple exhaust holes (62). The air tube is formed on the suction cap (60) to engage the air nipple (42) on the connecting cap (40). The check valve (61) is mounted in the air tube to prevent air from flowing back into the container (10). The exhaust holes are defined in the suction cap (60) to release any pressure generated by the vacuum gun (90).

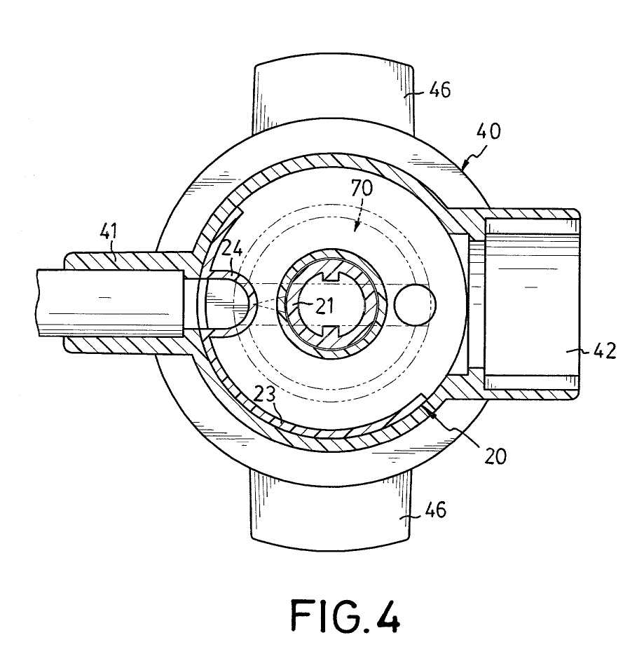

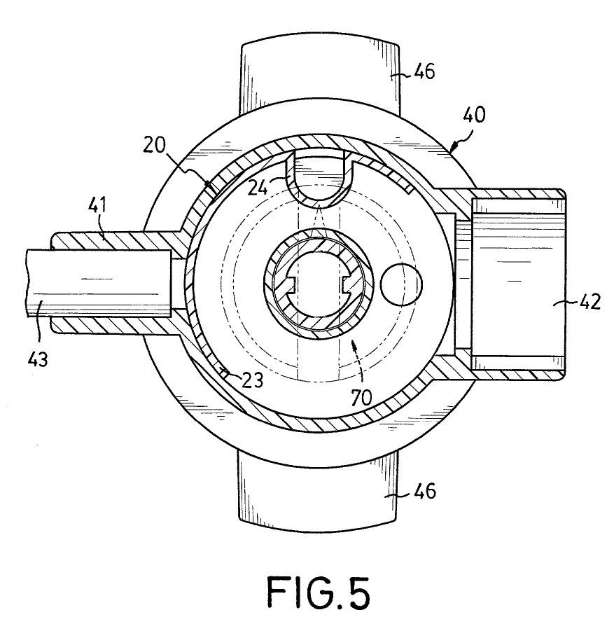

With reference to FIGS. 4 and 5, the adapter of the suction device is operated by inserting the extraction tube (43) into a patient's trachea, throat or other place fluid or phlegm blocking a passage or otherwise obstructing treatment must be removed. The knob (70) is turned to rotate the anti-leak base (20) to make the liquid guide (24) align with the liquid nipple (41). Then, the vacuum gun (90) is triggered to extract air from the container (81) to generate a suction to draw fluid out of patient's body. The fluid flows into the container (10) via the extraction tube (43) and the liquid nipple (41). When the fluid level in the container (10) increases to a sufficient level to reach the float ball (32), the float ball (32) is raised by the raising level of the liquid and blocks extension tube (27) to automatically stop the suction. Thereafter, the knob (70) is turned again to move the liquid guide trench (24) out of alignment with the liquid nipple (41) and make the division wall (23) block the liquid nipple (41). Therefore, the liquid nipple (41) is sealed to prevent liquid leakage even when the suction device is not standing upright.

Additionally, when the adapter for the suction device is not used, the scales (50) are detached from the container (10) and the container (10) is folded to reduce the volume of the container (10) for easy storage.

It should be clear to those skilled in the art that further embodiments can be made without departing from the scope and spirit of the present invention. Even though numerous characteristics and advantages of the present invention have been set forth in the foregoing description, together with details of the structure and function of the invention, the disclosure is illustrative only, and changes can be made in detail, especially in matters of shape, size, and arrangement of parts within the principles of the invention to the full extent indicated by the broad general meaning of the terms in which the appended claims are expressed.

What is claimed is:

1. An adapter for a suction device comprising:
a container (10) with a top, a bottom and an opening formed in the top of the container;
an anti-leak base (20) mounted on the opening of the container (10) being a round plate with a top surface, a bottom surface and an edge and having a nipple (25) attached to the bottom surface, a division wall (23) with an outer periphery protruding from part of the edge of the round plate and a liquid guide (24) defined inside the outer periphery of the division wall (23);
a liquid level controller (30) mounted on the bottom face of the anti-leak base (20) and comprising a floating check valve (31) communicating with the nipple (25) and a floating ball (32) movably mounted inside the floating check valve (31), wherein the floating check valve (31) has multiple longitudinal holes defined in the floating check valve (31) to allow the liquid inside the container (10) flowing into the floating check valve (31); and
a cap (40) detachably mounted on the opening in the container (10) having a liquid nipple (41) and an air nipple (42) formed on the cap (40), and a knob (70) rotatably secured on the top face of the cap (40) to rotate the anti-leak base (20) mounted inside the cap (40).

2. The adapter for a suction device as claimed in claim 1, wherein the container (10) is foldable and at least one mounting hole (12) is defined in an outer periphery of the container (10) near the bottom;
the cap (40) further has at least one bracket (46) formed on an outer periphery of the cap (40) corresponding to the at least one mounting hole (12) in the container (10); and
at least one scale (50) mounted on the container and each scale (50) having a hook (51) firmly engaged with one of the last one bracket (46) in the cap (40) and a wedge block (52) firmly engaged with corresponding one of the at least one mounting hole (12) in the container (12) to measure the liquid level.

3. The adapter for a suction device as claimed in claim 1, wherein the anti-leak base (20) further has a first cylindrical protrusion (21) formed at a center on the top surface of the round plate and a longitudinal hole (211) defined in the first cylindrical protrusion (21); and
the knob (70) has a shaft (71) with a threaded hole formed on a bottom face the knob (70) to penetrate the hole in the top of the cap (40) and attach to the first cylindrical protrusion (21) by a screw (72) through the longitudinal hole (211) and the threaded hole.

4. The adapter for a suction device as claimed in claim 2, wherein the anti-leak base (20) further has a first cylindrical protrusion (21) formed at a center on the top surface of the round plate and a longitudinal hole (211) defined in the first cylindrical protrusion (21); and
the knob (70) has a shaft (71) with a threaded hole formed on a bottom face of the knob (70) to penetrate the hole in the top of the cap (40) and attach to the first cylindrical protrusion (21) by a screw (72) through the longitudinal hole (211) and the threaded hole.

5. The adapter for a suction device as claimed in claim 1, wherein the anti-leak base (20) further a rim (22) formed around an outer periphery of the round plate (20); and
an extension tube (27) has a first end and a second end and communicates between the nipple (25) and the floating liquid level controller (30).

6. The adapter for a suction device as claimed in claim 2, wherein the anti-leak base (20) further has a rim (22) formed around an outer periphery of the round plate (20); and
an extension tube (27) has a first end and a second end and communicates between the nipple (25) and the liquid level controller (30).

7. The adapter for a suction device as claimed in claim 4, wherein the anti-leak base (20) further has a rim (22) formed around an outer periphery of the round plate (20); and
an extension tube (27) has a first end and a second end and communicates between the nipple (25) and the floating liquid level controller (30).
